(19) United States
(12) Patent Application Publication
(10) Pub. No.: US 2011/0167985 A1
(43) Pub. Date: Jul. 14, 2011

(54) CLUTCH WITH MULTIPLE RELEASE

(76) Inventors: Steve Holland, South Buckinghamshire (GB); Winfried Holl, Illertissen-Au (DE)

(21) Appl. No.: 12/858,205

(22) Filed: Aug. 17, 2010

(30) Foreign Application Priority Data
Jan. 11, 2010 (DE) 102010004313.3

(51) Int. Cl. G10D 13/02

(52) U.S. Cl. 84/422.3

(57) ABSTRACT

The present invention provides a multiple, in particular two-fold, releasable clutch (5), which can be closed via an intermediate position without a drummer having to use a foot. The clutch (5) is connected with at least an upper cymbal and further is formed with at least a first lever (1) and a second lever (2). A releasing of the first lever (1) causes a falling of the clutch (5) into an intermediate position, in which the upper cymbal (9) and a lower cymbal (10) are arranged in a half-closed position. By actuating the second lever (2), the clutch (5) can be arranged in an end position, wherein in the end position the upper cymbal (9) and the lower cymbal (10) are in a closed state.

The present invention concerns a clutch with multiple release and particularly a clutch with double release for use with a hi-hat.

In the field of drumming, a clutch, for example, is used together with a so called hi-hat (also referred to as sock cymbal). In a hi-hat, two cymbals are mounted on a rod. Therein, their concave faces are facing each other. The sound type of the hi-hat depends on whether the two cymbals are lying close-fitted on top of each other and thus enclose a volume due to their concave form, or whether they are arranged spaced from each other. For having provided both sound types, i.e., the one of the closed and the one of the open arrangement, the hi-hat is provided to have the position of the cymbals variable with respect to each other. For example, this can be performed by actuating a foot pedal. That means that generally, one foot is required for actuating the hi-hat. Therefore, this foot is not available for use with other instruments.

Therefore, hi-hats with release are popular among drummers from various styles of music, from Jazz to Heavy Metal. By releasing, the same effect can be achieved as if a foot is used for the controlling of the hi-hat, i.e., that the position of the two cymbals of the hi-hat can be varied between an open and a closed position with respect to each other. For varying and holding the closed or the open position, however, here a foot has not to be used, as in the case of common hi-hats.

From the U.S. Pat. No. 4,928,567 a hi-hat with a clutch is known, which has the ability to enable for a single release. The clutch is fixedly connected with an upper cymbal of the hi-hat. A horizontal lever therein is engaged with the clutch, such that in the starting position (an open position), the clutch and the upper cymbal are commonly arranged in a position spaced with respect to a lower cymbal. The engagement is released, if the lever is actuated by a vertical movement. By doing this, the clutch with the upper falls onto the lower cymbal, that means into the closed position. By actuating a foot pedal, the starting condition is re-established.

The problem of such a clutch with single release, as it is described in U.S. Pat. No. 4,928,567, is that only one open and one completely closed, fixed position can be achieved. However, in certain styles of music, it is desired to also establish half-closed plays of the hi-hat. In particular, this is desired in Heavy Metal. So far, the only possibility to play with a half-open position requires the use of one foot. Therefore, in particular the drummers of Heavy Metal have to compromise most with the conventional construction, since they usually need their feet for other purposes, for example the actuating of the bass drum with both feet.

Therefore, it is an object of the present invention, to provide a clutch enabling a play in half open position, without having to employ a foot for holding and controlling the position.

This object is achieved according to the invention by the device according to patent claim 1 and the use of the device according to patent claim 9, and the hi-hat with the device according to patent claim 10. Advantageous developments are subject to the dependent claims.

The advantages achieved with the invention are in particular, that a clutch of a clutch device can be moved and locked from a starting position into a releasable intermediate position by actuating a lever. By using the clutch device in combination with a hi-hat, the arrangement of two cymbals of the hi-hat in this intermediate position forms a half-closed state. Thus, an intermediate position can be achieved without the drummer having to use a foot to sustain this state. Therefore, the drummer is enabled to use both feet for other purposes.

Furthermore, it is advantageous that the clutch is held in the intermediate position by a second lever. Therefore, the clutch can be released from the second position by simply actuating the second lever. Such an actuation enables the drummer to bring the hi-hat into a different position during playing fast and easily.

Therefore, the upper cymbal of the hi-hat and the lower cymbal of the hi-hat can be arranged in two non-closed positions, in which there is no contact between the cymbals.

In a case, in which the clutch is fixed to the upper cymbal, the distance between the two cymbals of the hi-hat in this intermediate position is smaller than in the starting position. In another case, in which the clutch is mounted to the lower cymbal, this distance is smaller than in an end position. A drummer can create different sounds due to these distances differing from one another, without having to sustain a certain position of the hi-hat with a foot.

Furthermore, it is advantageous that the clutch can further be moved from an intermediate position into an end position. Thus, in addition to the functions of a common hi-hat, the hi-hat with a clutch with double release according to the invention also allows adjusting of the intermediate position by simply actuating levers.

It is a further advantage, that the movement of the clutch from the starting position into an intermediate position, or from an intermediate position into the end position can be caused either by gravitational force or due to an elastically or a hydraulically caused force, for example by release of a spring or the like.

It is also an advantage that the clutch can be brought from the end position directly into an intermediate position or into the starting position, or that the clutch can be brought from an intermediate position back into the starting position. This enables the drummer to individually and easily use the hi-hat. In particular, the drummer can reposition the hi-hat between the starting position and an intermediate position, without having to use the end position. It is also possible to choose the intermediate position directly from an end position by specific resetting of the hi-hat, without having to return into the starting position.

It is further advantageous that the hi-hat can be brought into one of the preceding positions by actuating a third lever. This third lever can be either a foot lever or a manual lever. Particularly in case of a manual lever, the resetting into a preceding position can be supported, for example by an elastic relaxation of a spring.

Details, advantages and further developments of the invention will be described more detailed by example of an embodiment referring to the figures. Therein show:

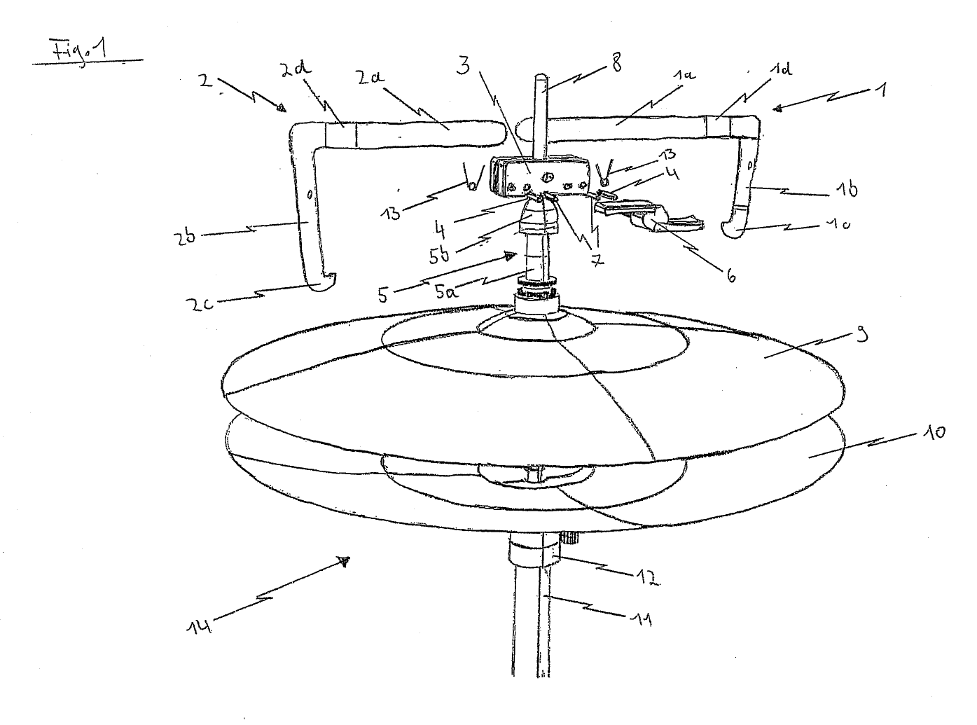

FIG. 1 an exploded view of a clutch with double release of the invention, being provided in a hi-hat;

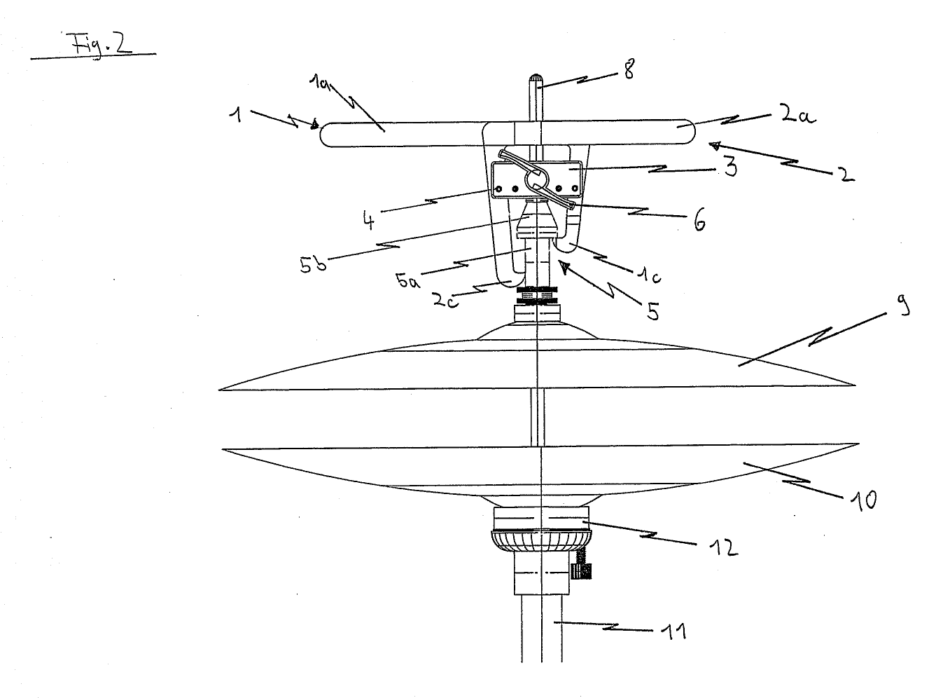

FIG. 2 the clutch with double release, according to the invention in starting position of the hi-hat;

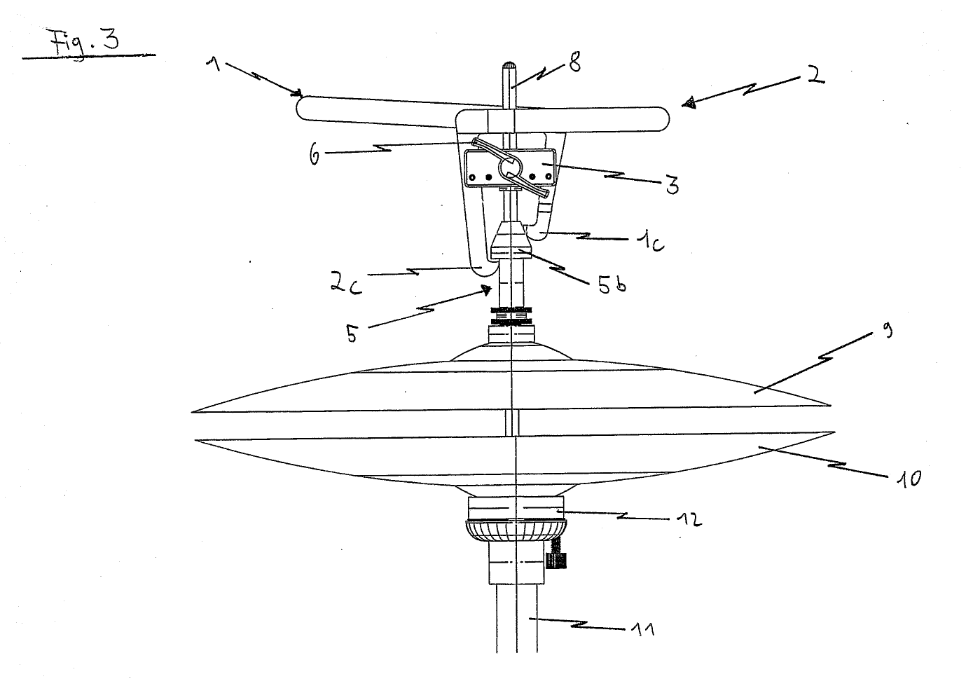

FIG. 3 the clutch with double release, according to the invention in an intermediate position of the hi-hat;

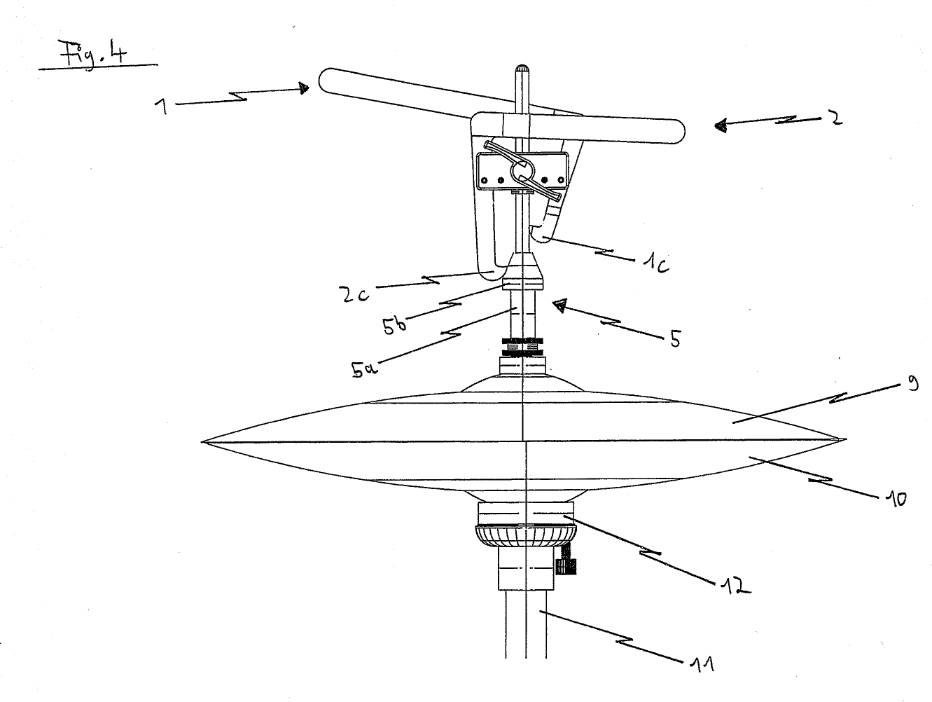

FIG. 4 the clutch with double release, according to the invention in an end position of the hi-hat;

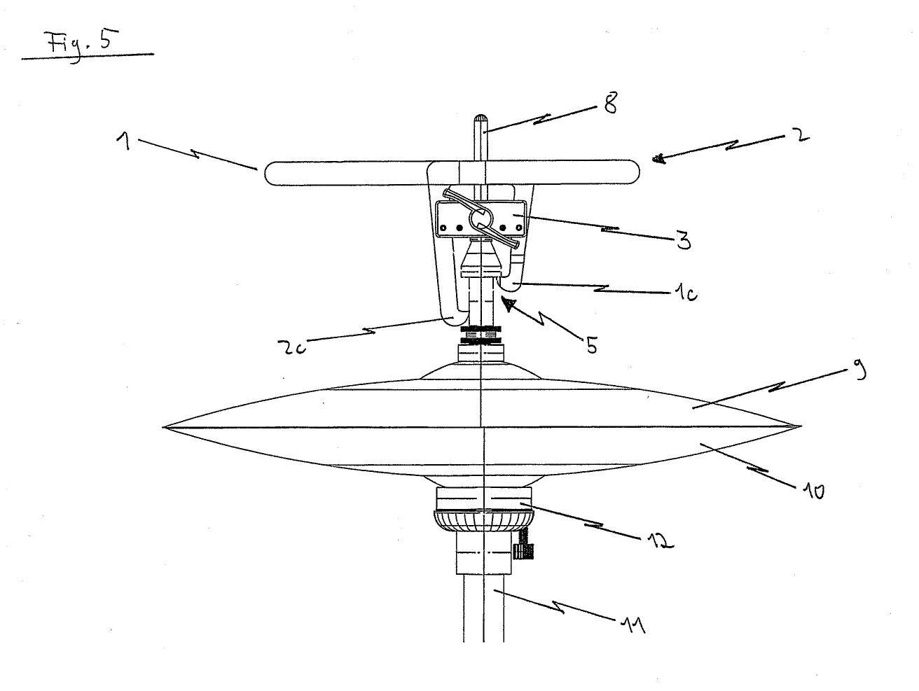

FIG. 5 the clutch with double release, according to the invention during resetting;

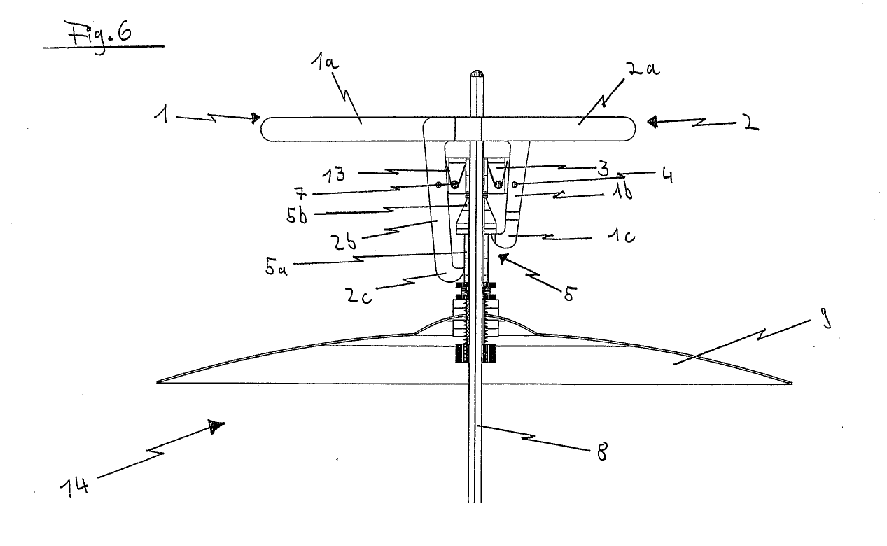

FIG. 6 a sectional view of the clutch with double release, according to the invention;

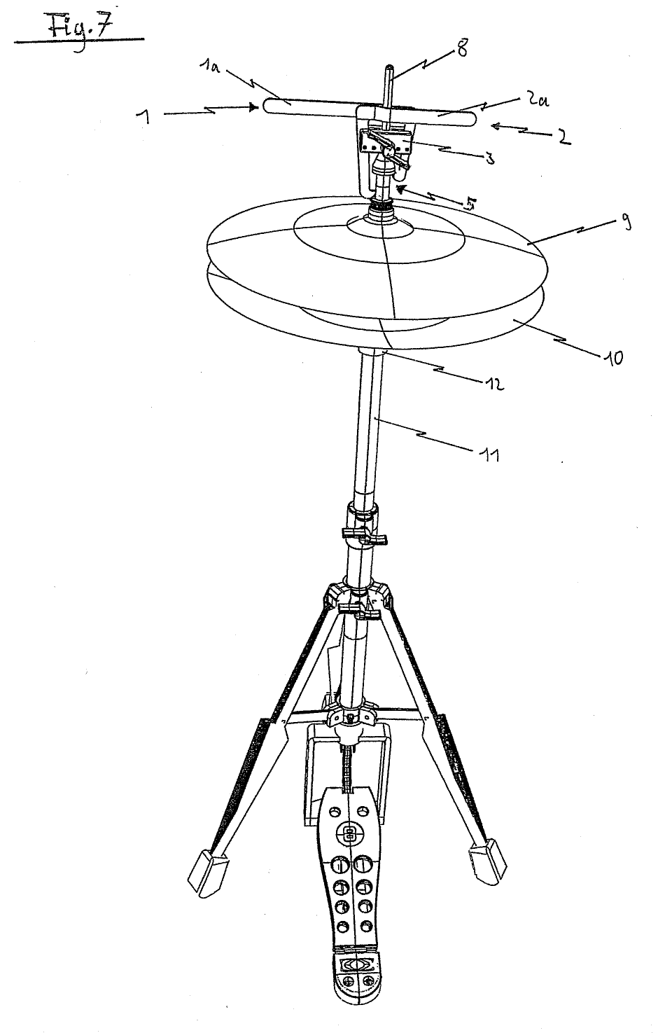

FIG. 7 a perspective view of a complete hi-hat with a clutch, according to the invention.

The illustration in FIG. 1 shows an exploded view of a hi-hat 14 comprising a slaving part formed as a clutch 5. In a preferred embodiment, the clutch 5 comprises a tube-like portion 5a and a cone-shaped portion 5b. The cone-shaped portion 5b is formed above the tube-like portion 5a and is tapered in vertical direction to the top. A diameter of the base of the cone-shaped portion 5b is bigger than the diameter of the tube-like portion 5a.

In a lower region of the tube-like portion 5a the clutch 5 is mounted at an upper instrument of the hi-hat 14. In the preferred embodiment, the upper instrument is an upper cymbal 9. The clutch 5 serves as a fixing means for the cymbal. Therein, the clutch 5, as well as the upper cymbal 9, is provided with a center axis opening, such that they can be mounted onto a rod, in the preferred case a pulling rod 8. The upper cymbal 9 is a common cymbal, as it is used for drums, and will not be described in detail herein.

It is to be noted that the slaving member, i.e., the clutch 5, and the upper cymbal 9 are not mounted to the pulling rod 8 in the preferred embodiment. Rather, the clutch 5 can be moved with the upper cymbal 9 along the pulling rod 8.

In the preferred embodiment, the fixing means is provided above the clutch 5, formed as a tensioning member 3. As can be seen from FIG. 1, the tensioning member 3 essentially consists of an extruded plate. The tensioning member 3 is formed such that it can be arranged around the pulling rod 8. Further, the tensioning member 3 comprises four through holes being arranged such that two are located on each side of the pulling rod 8 and the other two through holes correspondingly are located on the other side of the pulling rod 8.

In another embodiment, the tensioning member can also consist of two individual plates. The plates comprise the same drills as described above, and are arranged on opposing sides of the pulling rod 8. Thereby, the holes corresponding to each other of the two plates coincide with one another.

In the described embodiment, one pair of holes closer to the pulling rod 8 serves for receiving fixing screws 7 for a lever-tensioning spring 13. The pair of holes is arranged on two different sides of the pulling rod 8, as can also be seen from FIG. 1. The lever-tensioning spring 13 is arranged in the tensioning member 3 such that a fixing screw 7 extends through the lever-tensioning spring 13. The lever-tensioning spring 13 is further arranged such that in particular a tensioning effect is acting in the radial direction with respect to the pulling rod 8. The lever-tensioning spring 13 is a spring with a spring coil and two portions perpendicularly protruding from a coil axis. A tensioning force for this spring acts in the direction perpendicular to the coil axis of the spring and the extension direction of the protruding portions.

Pivotal point screws 4 are provided in a second pair of holes of the tensioning member 3, located further away from the pulling rod 8 than the pair of holes for receiving the fixing screws. In a preferred embodiment, the holes are arranged such that the pivotal point screws 4 provided therein engage with corresponding holes of a first lever 1 and a second lever 2. These levers 1 and 2 will be described in more detail later on.

In other embodiments, it is also possible that more or also fewer holes are provided in the tensioning member, for achieving the same purpose of fixing.

Furthermore, the tensioning member 3 is provided with at least one hole through the center directed toward the pulling rod 8. This hole serves for receiving a mounting screw 6 for mounting the tensioning member 3 at the pulling rod 8. This mounting screw 6 for example can be formed as a thumbscrew.

The tensioning member 3 is tightly connected to the pulling rod 8. Further, in the preferred embodiment, no direct connection between the tensioning member 3 and the clutch 5 is provided. However, it is possible that the clutch 5 is connected to the tensioning member 3 via moving means, for instance via an elastic or hydraulic element. Thus, a movement of the clutch along the pulling rod 8 is possible, which is elastically or hydraulically caused. Thus, the clutch 5 can be returned into the starting position either from an intermediate position or from the end position. The clutch 5 can also be returned into at least one intermediate position from the end position.

The clutch device further comprises a first actuating means 1 and, in a preferred embodiment, a second actuating means 2. The first actuating means 1 and the second actuating means 2 serve for supporting the clutch 5 in various positions along the pulling rod 8, as will be described in detail later on.

In the described embodiment, the first actuating means 1 is formed as a first lever 1 (lever for upper fixation) and the second actuating means is formed as a second lever 2 (lever intermediate step). The first lever 1 and the second lever 2 are each formed in an L-shape. A first leg 1a, 2a of the first and the second levers 1, 2 extends in horizontal direction radially outward from the pulling rod 8. The first leg 1a, 2a further comprises a curved portion 1d, 2d formed such that the first leg 1a, 2a can be arranged around the pulling rod 8.

The corresponding second leg 1b, 2b of the lever 1 and 2, respectively, essentially is arranged at a right angle with respect to the first leg 1a, 2a in the preferred embodiment, and extends in a preferred embodiment in a vertical direction toward the upper cymbal 9. Therein, the second leg 1b, 2b is arranged at the inner end of the first leg 1a, 2a closer to the pulling rod 8. Further, the second leg 1b, 2b is located on the opposite side of the pulling rod 8 compared to the side on which the first leg 1a, 2a is radially extending outward. The first lever 1 and the second lever 2 thus each extend around the pulling rod 8 (compare FIG. 2). The second leg 1b of the first lever 1 is formed shorter than the second leg 2b of the second lever 2.

In another embodiment, the angle in which the second leg is angled from the first leg can be an acute or obtuse angle.

An end portion 1c, 2c of the respective second levers 1b, 2b is formed in a hook shape. The hook is formed such that it is facing the pulling rod 8 and can engage with the clutch.

In a preferred embodiment of the present invention, the hook is pushed against the pulling rod 8 by the spring force of the lever-tensioning spring. The hook-shaped portion 1c, 2c is also in contact with the pulling rod 8.

Further, a through hole is provided in the second leg 1b, 2b, which is made to coincide with the above described outer through holes in the plates of the tensioning member 3. Thereby, the corresponding pivotal point screw 4 receives the respective second leg 1b, 2b. The lever tensioning spring 13 therein permanently acts as a restoring force onto the levers 1, 2, acting in the direction toward the pulling rod 8.

It is also conceivable that in another embodiment, the pivotal point of the first or the second lever 1, 2 is not provided at the second leg 1b, 2b but rather at the first leg 1a, 2a. Further, it is conceivable that the second leg 1b, 2b is arranged elastically or pivotally with respect to the first lever.

Below the upper cymbal 9, a lower instrument, here a lower cymbal 10, is arranged. The upper cymbal 9 and the lower cymbal 10 each have a concave shape. The upper cymbal 9 is aligned downwardly with its concave face, whereas the lower cymbal 10 is aligned upwardly with the concave face. In analogy to the upper cymbal 9, the lower cymbal 10 comprises a through hole in the center, through which the pulling rod 8 vertically extends.

The lower cymbal 10 rests on a cymbal rest 12 for the lower cymbal 10. The cymbal rest in turn is arranged around the upper tube 11 of the hi-hat 14 and mounted thereon. The upper tube 11 comprises an inner diameter enabling reception of the pulling rod 8. Both the upper and the lower cymbal 9, 10 essentially are horizontally arranged, as can be seen for example from FIG. 2. In the further downward run, the upper tube 11 joins a lower tube connected with the tripod of the hi-hat 14 (compare FIG. 7).

In the preferred embodiment, the pulling rod 8 extends through the components described above to the tripod of the hi-hat (compare FIG. 7). At the tripod of the hi-hat, the pulling rod 8 is connected with a resetting means. In the described embodiment of the hi-hat 14, the resetting means comprises an elastic member and in particular they are formed as a third lever (foot pedal). In other embodiments, the third lever can also be located at positions other than the foot of the hi-hat 14. The resetting means may also comprise an elastic member supporting resetting due to an elastic release to be applied to the elastic member.

Particularly, the third lever does not have to be actuated by foot. It is conceivable that an operation is possible by hand, particularly in combination with a spring supported resetting.

In the following the use of the hi-hat with a clutch 5 with double release according to the invention, will be described for illustration purposes.

In a preferred embodiment of the present invention the hi-hat 14 and thus both the clutch 5 and the upper cymbal 9 are situated in the starting position (FIG. 2). Therefore, the first lever 1 and the second lever 2 are connected at the tensioning member 13 via the pivotal point screw 4. The tensioning member 3 is connected to the pulling rod 8 by means of the mounting screw 6.

The cone-shaped portion of the clutch 5 according to the invention comprises a lower edge radially protruding from the cube-shaped portion 5a of the clutch 5. In the starting position, the hook-shaped portion 1c of the second leg 1b of the first lever 1 engages with the lower edge of the cone-shaped portion 5b of the clutch 5. The hook-shaped portion 1c therein is pushed toward the pulling rod 8 due to the elasticity of the lever-tensioning spring 13. The lower edge of the cone-shaped portion 5b of the clutch 5 therefore rests on the hook-shaped portion 1c of the first lever 1.

In analogy to the arrangement of the first lever 1, the hook-shaped portion 2c of the second leg 2b of the second lever 2 is pushed against the pulling rod 8.

The first lever 1 can be deflected in a vertical direction toward the upper cymbal 9 by a vertical force (as it is exerted, for instance, by a hit with a drumstick, FIG. 3). This corresponds to a first release of the clutch. Thereby, a pivoting of the first lever 1 around the pivotal point screw 4 is caused. The second leg 1b is deflected from its essentially vertical position in a radial direction, and the hook-shaped portion 1c of the second leg 1b is not in contact with the clutch 5 anymore. Consequently, the hook-shaped portion 1c cannot support the clutch 5 anymore and the clutch 5 moves downward toward the lower cymbal together with the upper cymbal. This movement is effected by gravity.

In the preferred embodiment, this movement is a free fall. In other embodiments, however, it is possible that the fall is elastically supported, caused, or damped, for instance by a spring. For example, it is possible that actuating the first lever causes a hydraulic adjusting of the upper cymbal.

In a further embodiment of the invention it is possible that by releasing the first lever a spring supports or causes the movement of the clutch, and thus of the upper cymbal, and pushes the clutch toward the lower cymbal.

In another embodiment, it is also possible that the first lever does not have to comprise a hook-shaped portion for supporting the clutch. It is possible that by a corresponding hydraulic control of the clutch a continuous setting can be. performed by the movement of the clutch directly following the movement of the lever and not being separated from the lever.

Analogously, these two developments of the invention are also applicable to further levers.

If the vertical force on the first lever 1 is released again, the first lever 1 is pushed back into the vertical position due to the elasticity of the lever-tensioning spring 13. The hook-shaped portion 1c of the first lever 1 therefore approaches the pulling rod 8 again.

By the arrangement of the first or second lever 1, 2 around another through hole appropriately provided, as described above, the lever-tensioning spring can be omitted, since a restoring force only due to the weight of the lever can push the hook-shaped portion 1c, 2c against the pulling rod 8.

In the preferred embodiment, the intermediate positions are positions in which the upper cymbal 9 is arranged in a distance from the lower cymbal 10 smaller than in the starting position.

Due to the lever-tensioning spring 13, as described above, the second lever 2 is arranged to be in contact with the pulling rod 8 by the hook-shaped portion 2c. As shown in FIG. 3, the clutch 5 therefore falls from the starting position into an intermediate position, by coming to rest on the hook-shaped portion 2c of the second lever 2. In this intermediate position, the second lever 2 therefore supports the clutch 5. Thus, a fixed intermediate position is enabled without the drummer having to use a foot.

It is to be noted, that the tensioning member 3 is arranged in a distance from the lower cymbal 10 such that the hook-shaped portion 2c of the second lever 2 holds the clutch 5 in a position in which the upper cymbal 9 and the lower cymbal 10 take a half-closed position. That means, the cymbals are closer to each other than in the open position, however, they are not in contact with each other. Due to this reason, the second portion of the second lever 2 is longer than the second leg 1b of the first lever 1.

Now, in the case of the clutch with double release, if it should be changed from this intermediate position into the end position (FIG. 4), the second lever 2 is deflected by a vertical force in a vertical direction toward the upper cymbal 9 in analogy to the first lever 1. This corresponds to a second releasing of the clutch 5. Thereby a pivoting of the first lever 1 is caused around the pivotal point screw 4. Thus, the engagement of the hook-shaped portion 2c is released and the second lever 2 does not support the clutch 5 together with the upper cymbal 9 anymore. The clutch 5 therefore moves from the intermediate position into the end position.

For a clutch with multiple releases, a further intermediate position can be achieved here, as will be described later on.

In the preferred embodiment, this movement also is a free fall. However, in other embodiments, it is possible, analogously to the case of the movement between the starting position and the intermediate position, that the fall can, for instance by a spring, be elastically caused, supported or damped, in analogy to the above described case.

If the vertical force on the second lever 2 is released again, the second lever 2 is pushed back into the vertical position due to the elasticity of the lever-tensioning spring 13. The hook-shaped portion 2c of the second lever 2 thus approaches the pulling rod 8 again.

As is shown in FIG. 4, in the closed position of the preferred embodiment the upper cymbal 9 rests on the lower cymbal 10. As soon as the vertical force is released from the second lever 2, the hook-shaped portion is pushed against the pulling rod 8 again due to the elasticity of the lever-tensioning spring 13.

FIG. 5 shows a fetching of the clutch 5. This fetching can be caused by the pulling rod 8 being displaced downwardly in a vertical direction. This displacement is caused by means of a third lever (foot pedal in FIG. 7) in the preferred embodiment. By actuating the third lever, the pulling rod is pulled downward together with the tensioning member. Due to the cone-shaped characteristics of the cone-shaped portion 5b of the clutch 5, the cone-shaped portion 5b first is pushed beneath the hook-shaped portion 2c of the second lever 2, until the second lever 2 again engages below the lower edge of the cone-shaped portion 5b of the clutch.

If the actuation of the third lever is interrupted in this stage, the clutch 5 and thus the upper cymbal 9 can directly be restored from the end position to the intermediate position. However, if the third lever is further actuated, the cone-shaped portion 5b of the clutch 5 is also pushed beneath the hook-shaped portion 1c of the first lever 1.

After finishing the actuation of the third lever, the pulling rod 8 is pushed upwardly in the vertical direction, for instance by spring force (depending on the mechanism applied in the third lever). Due to the engagement of either the first lever 1 or the second lever 2 the clutch 5 is also lifted into the starting or the intermediate position, accordingly.

Optionally, by actuating the third lever, the clutch 5 can also be brought into the starting position from an intermediate position. For this, the third lever has to be actuated when the clutch 5 is positioned in the intermediate position, without bringing the clutch into the end position.

In a further embodiment not shown, it is possible that only one lever is used for double releasing of the clutch. In this case, the clutch comprises two cone-shaped portions being arranged with a predetermined distance on top of each other. Due to a first releasing, the clutch falls from the starting position into an intermediate position, wherein in both cases the lower edge of the corresponding cone-shaped portion of the clutch rests on the same hook-shaped portion. The lever or the restoring force has to be provided such that the lever can return into its starting position (in contact with the clutch) sufficiently fast after its releasing.

Further, it is conceivable that by providing a plurality of cone-shaped portions (for instance two) and of a plurality of levers with hook-shaped portions (for instance two) multiple release is possible, enabling for a multiplicity of positions (in this example five positions). Herein, in starting position, a first (lower) cone-shaped portion of the clutch is supported by a first lever. By releasing the first lever, the clutch falls into a first intermediate position and the first cone-shaped portion is supported by the second lever. A further releasing causes a falling of the clutch into a second intermediate position. In this second intermediate position the first lever engages with a second cone-shaped portion of the clutch. A further releasing of the first lever then causes the movement into a third intermediate position, in which the second lever then supports the second cone-shaped portion of the clutch. A further releasing of the second lever then causes a movement into the end position.

Further, it is possible that a plurality of levers is provided, which, in analogy to the above described embodiments, allow a plurality of intermediate positions.

It is further conceivable that in an alternative embodiment a spring pre-tension is used for restoring the clutch, which was caused by a single or multiple release of one or more levers.

Further, it can be imagined that the above described principle can be applied to a clutch sitting below the lower cymbal. The lower cymbal here rests on the clutch and can be connected with it. In the starting position the upper and the lower cymbals are in contact with each other. By releasing of a first lever, the clutch together with the upper cymbal falls into an intermediate position. Therefore, in this intermediate position, the distance between the upper and the lower cymbal is bigger than in the starting position. By further releasing of the clutch, the distance of the cymbals with respect to each other can be increased in analogy to the above described embodiments successively up to a final distance in the end position. A restoring can be caused by means of a third lever in analogy to the restoration described above, wherein the clutch pushes the lower cymbal toward the upper cymbal.

The present invention thus provides a multiple, in particular twofold, releasable clutch 5, which can be closed via an intermediate position without a drummer having to use a foot. The clutch 5 is formed with at least a first lever 1 and a second lever 2. A releasing of the first lever 1 causes a falling of the clutch 5 into an intermediate position, in which upper cymbal 9 and lower cymbal 10 are arranged in a half-closed position. By actuating the second lever 2, the clutch 5 can be brought into an end position or into a further intermediate position, wherein in the end position of the preferred embodiment the upper cymbal 9 and the lower cymbal 10 are in a closed state.

1. Clutch device for a hi-hat, wherein the hi-hat comprises a rod and the clutch comprises the following members:
a fixing means fixed at the rod,
a slaving member moveable along the rod between a starting and an end position,
a first actuating means moveably supported at the fixing means and formed such that it is moveable into an engaging position, in which it is engageable with the slaving member if the slaving member is located in the starting position,
wherein the slaving member is moveable from a starting position into an end position if the actuating means is brought into a non-engaging position, in which it is non-engaged with the slaving member, characterized in that the clutch device is formed such that at least one intermediate position is provided between the starting and the end position, in which the slaving member is releasably arrestable.

2. Clutch device according to claim 1, wherein the clutch device comprises a second actuating means, formed such that it is moveable into an engaging position, in which it is engageable with the slaving member, if the slaving member is situated in an intermediate position.

3. Clutch device according to claim 1, wherein the slaving member is arrangeable from at least one intermediate position into a further intermediate position or into the end position by de-engaging of the actuating means.

4. Clutch device according to claim 1, wherein the slaving member is moveable vertically along the rod, and the vertical movement from the starting position into one of the intermediate positions and/or the movement from one of the intermediate positions into a further intermediate position or into the end position is caused by gravity.

5. Clutch device according to claim 3, wherein a moving means is further provided being in operative connection with the slaving member, and wherein by actuation of the moving means a movement of the slaving member from the starting position into one of the intermediate positions and/or the movement from one of the intermediate positions into the end position is caused elastically or hydraulically.

6. Clutch device according to claim 1, wherein a restoring means is provided such that it restores the slaving member from one of the intermediate positions as well as of the end position into the starting position, or restores the moveable member from the end position into at least one of the intermediate positions.

7. Clutch device according to claim 6, wherein the restoring means is a foot pedal.

8. Clutch device according to claim 7, wherein the restoring means comprises an elastic member supporting restoration due to an elastic release in the elastic member.

9. (canceled)

10. (canceled)

11. Clutch device according to claim 2, wherein the slaving member is arrangeable from at least one intermediate position into a further intermediate position or into the end position by de-engaging of the actuating means.

12. Clutch device according to claim 2, wherein the slaving member is moveable vertically along the rod, and the vertical movement from the starting position into one of the intermediate positions and/or the movement from one of the intermediate positions into a further intermediate position or into the end position is caused by gravity.

13. Clutch device according to claim 3, wherein the slaving member is moveable vertically along the rod, and the vertical movement from the starting position into one of the intermediate positions and/or the movement from one of the intermediate positions into a further intermediate position or into the end position is caused by gravity.

14. Clutch device according to claim 2, wherein a restoring means is provided such that it restores the slaving member from one of the intermediate positions as well as of the end position into the starting position, or restores the moveable member from the end position into at least one of the intermediate positions.

15. Clutch device according to claim 3, wherein a restoring means is provided such that it restores the slaving member from one of the intermediate positions as well as of the end position into the starting position, or restores the moveable member from the end position into at least one of the intermediate positions.

16. Clutch device according to claim 4, wherein a restoring means is provided such that it restores the slaving member from one of the intermediate positions as well as of the end position into the starting position, or restores the moveable member from the end position into at least one of the intermediate positions.

17. Clutch device according to claim 5, wherein a restoring means is provided such that it restores the slaving member from one of the intermediate positions as well as of the end position into the starting position, or restores the moveable member from the end position into at least one of the intermediate positions.

18. Clutch device according to claim 6, wherein the restoring means comprises an elastic member supporting restoration due to an elastic release in the elastic member.

19. A hi-hat, comprising a rod and a clutch device, wherein the clutch comprises:
a fixing means fixed at the rod;
a slaving member moveable along the rod between a starting position and an end position; and
a first actuating means moveably supported at the fixing means and formed such that it is moveable into an engaging position, in which it is engageable with the slaving member if the slaving member is located in the starting position;
wherein the slaving member is moveable from the starting position into the end position if the actuating means is brought into a non-engaging position, in which it is non-engaged with the slaving member;
characterized in that the clutch device is formed such that at least one intermediate position is provided between the starting position and the end position, in which the slaving member is releasably arrestable.
